(19) United States
(12) Patent Application Publication
(10) Pub. No.: US 2015/0110312 A1
(43) Pub. Date: Apr. 23, 2015

(54) INPUT STAGE HEADROOM EXPANSION FOR HEARING ASSISTANCE DEVICES

(71) Applicants: Yezihalem Mesfin, Eden Prairie, MN (US); Michael Karl Sacha, Chanhassen, MN (US)

(72) Inventors: Yezihalem Mesfin, Eden Prairie, MN (US); Michael Karl Sacha, Chanhassen, MN (US)

(73) Assignee: Starkey Laboratories, Inc., Eden Prairie, MN (US)

(21) Appl. No.: 14/060,148

(22) Filed: Oct. 22, 2013

(51) Int. Cl. H04R 25/00

(52) U.S. Cl. CPC H04R 25/30; H04R 2201/003; H04R 2225/021; H04R 2225/023; H04R 2225/025
USPC 381/312

(57) ABSTRACT

Disclosed herein, among other things, are systems and methods for input stage headroom expansion for hearing assistance devices. One aspect of the present subject matter includes a hearing assistance device. According to various embodiments, the hearing assistance device includes an input stage including a microphone configured with variable sensitivity, and hearing assistance electronics connected to the microphone. The hearing assistance electronics are configured to process a signal received by the microphone for hearing assistance for a wearer of the hearing assistance device, in an embodiment. A receiver is connected to the hearing assistance electronics and configured to output the processed signal to the user, in various embodiments. According to various embodiments, the hearing assistance electronics are configured to dynamically change the sensitivity of the microphone to change headroom of the input stage.

### TECHNICAL FIELD

This document relates generally to hearing assistance systems and more particularly to methods and apparatus for input stage headroom expansion for hearing assistance devices.

### BACKGROUND

Hearing assistance devices, such as hearing aids, include, but are not limited to, devices for use in the ear, in the ear canal, completely in the canal, and behind the ear. Such devices have been developed to ameliorate the effects of hearing losses in individuals. Hearing deficiencies can range from deafness to hearing losses where the individual has impairment responding to different frequencies of sound or to being able to differentiate sounds occurring simultaneously. The hearing aid in its most elementary form usually provides for auditory correction through the amplification and filtering of sound.

Hearing aids typically include an enclosure or housing, a microphone, hearing assistance device electronics including processing electronics, and a speaker or receiver. Existing hearing aid microphones have a fixed sensitivity, meaning the electrical output of the microphone linearly increases or decreases with the input sound pressure in one-to-one ratio (i.e., a 1 dbSPL increase in input results in a 1 dB increase in the electrical output) up to the maximum sound pressure the microphone can handle without distortion.

The input stage of the hearing aid circuit can accommodate an input level to a certain threshold point beyond which it starts clipping and distorting, which is referred to as headroom. When the microphone is connected to the hearing aid circuit, the system establishes a system-level input threshold or clipping level. This system-level clipping level is determined by the sensitivity of the microphone and the maximum input level of the hearing aid circuit. The clipping level can be a limitation in processing signals with transient peaks, such as music, and could result in the degradation of signal quality.

Accordingly, there is a need in the art for methods and apparatus for input stage headroom expansion for hearing assistance devices.

### SUMMARY

Disclosed herein, among other things, are systems and methods for input stage headroom expansion for hearing assistance devices. One aspect of the present subject matter includes a method for adjusting input stage headroom in a hearing assistance device. In various embodiments, the method includes sensing input sound pressure level for a hearing assistance device. The method also includes dynamically changing sensitivity of a microphone of the hearing assistance device to change headroom of an input stage of the hearing assistance device based on the sensed input sound pressure level, in various embodiments.

One aspect of the present subject matter includes a hearing assistance device. According to various embodiments, the hearing assistance device includes an input stage including a microphone configured with variable sensitivity, and hearing assistance electronics connected to the microphone. The hearing assistance electronics are configured to process a signal received by the microphone for hearing assistance for a wearer of the hearing assistance device, in an embodiment. A receiver is connected to the hearing assistance electronics and configured to output the processed signal to the user, in various embodiments. According to various embodiments, the hearing assistance electronics are configured to dynamically change the sensitivity of the microphone to change headroom of the input stage.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows a block diagram of a hearing assistance device, according to various embodiments of the present subject matter.

FIG. 2 illustrates a flow diagram of a method for adjusting input stage headroom in a hearing assistance device, according to various embodiments of the present subject matter.

FIG. 3 shows a block diagram of a hearing aid, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aids typically include an enclosure or housing, a microphone, hearing assistance device electronics including a processor, and a speaker or receiver. Existing microphones have a fixed sensitivity, meaning the electrical output of the microphone linearly increases or decreases with the input sound pressure in one-to-one ratio (i.e., a 1 dbSPL increase in input results in a 1 dB increase in the electrical output) up to the maximum sound pressure the microphone can handle without distortion.

The input stage of the hearing aid circuit can accommodate an input level to a certain threshold point beyond which it starts clipping and distorting, which is referred to as headroom. When the microphone is connected to the hearing aid circuit, the system establishes system-level input threshold or clipping level. This system-level clipping level is determined by the sensitivity of the microphone and the maximum input level of the hearing aid circuit. The clipping level can be a limitation in processing signals with transient peaks, such as music, and could result in the degradation of the signal quality.

The present subject matter solves the problem of clipping in the hearing aid's analog front end during the processing of signals with wide dynamic ranges, such as music. Previously, the method used to address this problem was the reduction of preamplifier gain in the hearing aid circuit to the lowest value to achieve the maximum possible headroom. This method is sufficient for certain applications, but does not provide a finer resolution (limited to 3 dB steps) in gain reduction and results in audio artifacts if the preamplifier gain is increased or decreased dynamically.

Disclosed herein, among other things, are systems and methods for input stage headroom expansion for hearing assistance devices. One aspect of the present subject matter includes a hearing assistance device. According to various embodiments, the hearing assistance device includes an input stage including a microphone configured with variable sensitivity, and hearing assistance electronics connected to the microphone. The hearing assistance electronics are configured to process a signal received by the microphone for hearing assistance for a wearer of the hearing assistance device, in an embodiment. A receiver is connected to the hearing assistance electronics and configured to output the processed signal to the user, in various embodiments. According to various embodiments, the hearing assistance electronics are configured to dynamically change the sensitivity of the microphone to change headroom of the input stage. In one embodiment, the microphone includes a microelectromechanical system (MEMS) microphone. In various embodiments, the MEMS microphone has a sensitivity that can be varied by changing the bias voltage of the microphone. The hearing assistance electronics include a digital signal processor (DSP), in various embodiments.

In various embodiments, the present subject matter provides for dynamic reduction of the sensitivity of the microphone to increase the sound pressure at which the analog front end starts clipping. At lower microphone sensitivity, the system clips at a higher input sound pressure, thus the headroom of the input stage is expanded. In addition, various embodiments of the present subject matter provide finer adjustment steps (in the order of 0.2 dB) and the option of adjusting the sensitivity of the microphone with minimum audio artifacts through an analog or digital interface between the hearing aid's firmware and the microphone.

According to various embodiments, device firmware takes a time window average of the incoming signal and commands the microphone to change its sensitivity. The microphone includes minimum, maximum and intermediate sensitivity values stored in its permanent memory that can be set through the hearing aid firmware, in various embodiments. In one embodiment, the microphone can be calibrated and the offset from a nominal sensitivity can be stored in its memory. The microphone includes a digital interface to communicate with the hearing aid, in various embodiments. In various embodiments, the digital instructions from the firmware increase and decrease the sensitivity with a predetermined increment and decrement steps hardcoded in the microphone, such as by using a clocked digital communication. In various embodiments, the digital instructions from the firmware increase and decrease the sensitivity specifying the increment and decrement steps, such as by using a clocked digital communication. In various embodiments, the digital instructions from the firmware only switch between maximum and minimum sensitivity values, without any intermediate sensitivity values. This embodiment can be used with a digital logic, such as a GPIO line, without further digital communication. The present subject matter improves hearing aid music processing, in an embodiment. The microphones can be calibrated at manufacture to match a nominal sensitivity, in various embodiments.

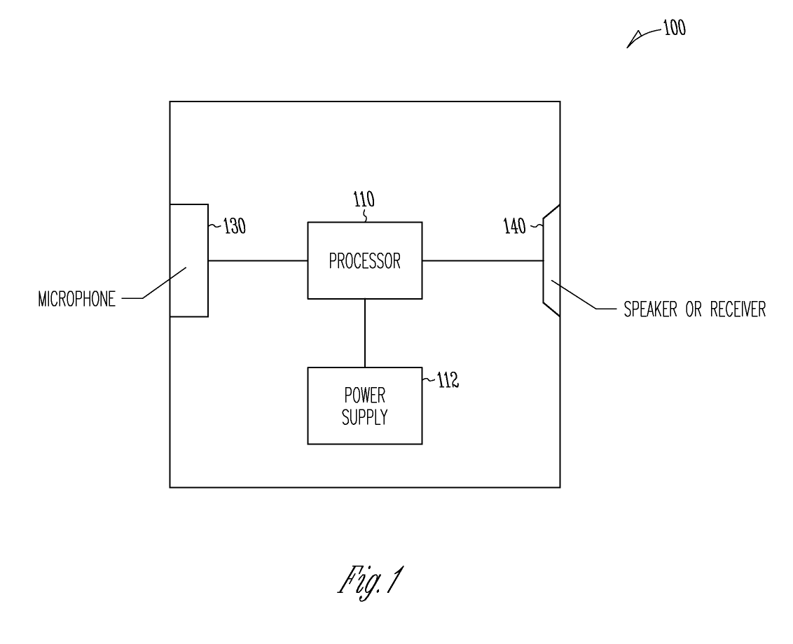

FIG. 1 shows a block diagram of a hearing assistance device 100 according to one embodiment of the present subject matter. In this exemplary embodiment the hearing assistance device 100 includes hearing assistance electronics such as a processor 110 and at least one power supply 112. In one embodiment, the processor 110 is a digital signal processor (DSP). In one embodiment, the processor 110 is a microprocessor. In one embodiment, the processor 110 is a microcontroller. In one embodiment, the processor 110 is a combination of components. It is understood that in various embodiments, the processor 110 can be realized in a configuration of hardware or firmware, or a combination of both. In various embodiments, the processor 110 is programmed to provide different processing functions depending on the signals sensed from the microphone 130. In hearing aid embodiments, microphone 130 is configured to provide signals to the processor 110 which are processed and played to the wearer with speaker 140 (also known as a “receiver” in the hearing aid art).

One example, which is intended to demonstrate the present subject matter, but is not intended in a limiting or exclusive sense, is that the signals from the microphone 130 are detected to sense input sound pressure level for the hearing assistance device. The processor 110 dynamically changes sensitivity of the microphone 130 of the hearing assistance device to change headroom of an input stage of the hearing assistance device based on the sensed input sound pressure level, in various embodiments. In various embodiments, more than one processor is used.

Other inputs may be used in combination with the microphone. For example, signals from a number of different signal sources can be detected using the teachings provided herein, such as audio information from a FM radio receiver, signals from a BLUETOOTH or other wireless receiver, signals from a magnetic induction source, signals from a wired audio connection, signals from a cellular phone, or signals from any other signal source.

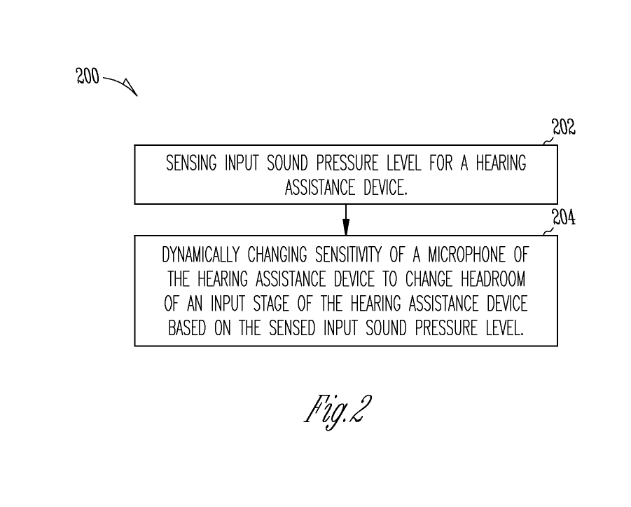

FIG. 2 illustrates a flow diagram of a method for adjusting input stage headroom in a hearing assistance device, according to various embodiments of the present subject matter. In various embodiments, the method 200 includes sensing input sound pressure level for a hearing assistance device, at 202. The method also includes, at 204, dynamically changing sensitivity of a microphone of the hearing assistance device to change headroom of an input stage of the hearing assistance device based on the sensed input sound pressure level, in various embodiments.

According to various embodiments of the method, dynamically changing sensitivity of a microphone includes changing a bias voltage of the microphone. Changing sensitivity includes decreasing sensitivity to increase the headroom, and/or increasing sensitivity to decrease the headroom, in various embodiments. In some embodiments, changing sensitivity includes using a predetermined increment level hardcoded in the microphone. Changing sensitivity includes specifying an increment level, in an embodiment. Changing sensitivity includes switching between a maximum and a minimum sensitivity value, in various embodiments. In one embodiment, switching between a maximum and a minimum sensitivity value includes using a GPIO processor line. Sensing input sound pressure level includes taking an average over a predetermined time period, in various embodiments.

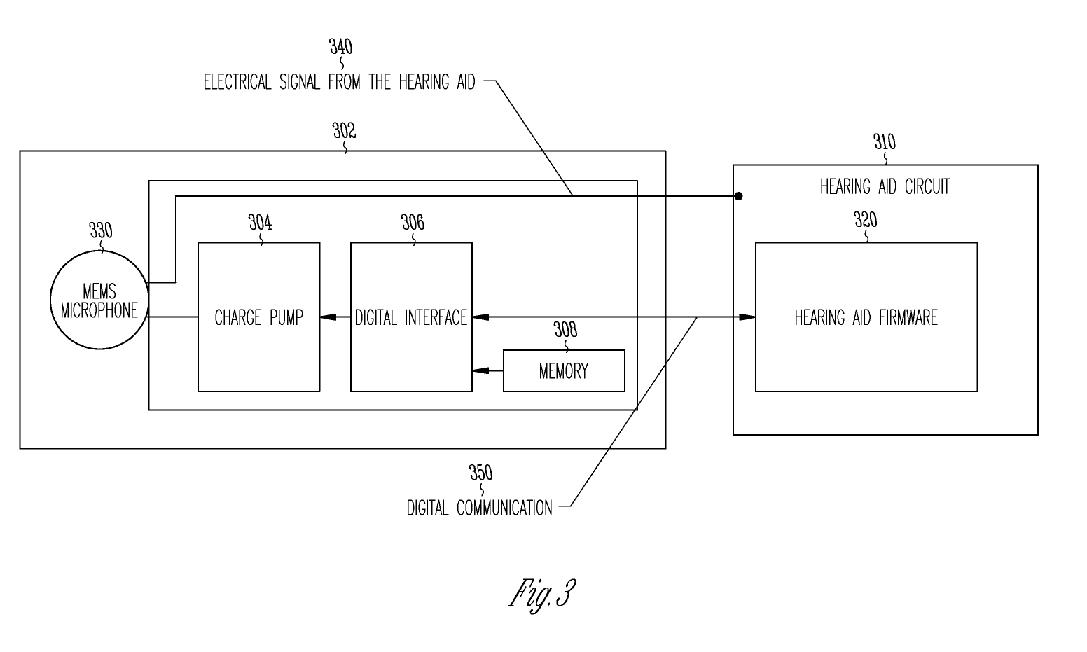

FIG. 3 shows a block diagram of a hearing aid, according to various embodiments of the present subject matter. According to various embodiments, the hearing aid includes an input stage 302 including a MEMS microphone 330 configured with variable sensitivity, a charge pump 304, a digital interface 306 and a memory 308. The hearing aid also includes a hearing aid circuit 310 having hearing aid firmware 320 executing thereon, in various embodiments. The hearing aid circuit 310 is configured to process an electrical signal 340 received by the microphone 330 for hearing assistance for a wearer of the hearing aid, in an embodiment. According to various embodiments, the hearing aid circuit 310 communicates using digital communication link 350 with the digital interface 306 to dynamically change the sensitivity of the microphone 330 to change headroom of the input stage 302.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, infrared, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the user.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, audio decoding, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), in-the-ear (ITE), in-the-canal (ITC), receiver-in-canal (RIC), completely-in-the-canal (CIC) or invisible-in-canal (IIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

In addition, the present subject matter can be used in other settings in addition to hearing assistance. Examples include, but are not limited to, telephone applications where noise-corrupted speech is introduced, and streaming audio for ear pieces or headphones.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method, comprising:
sensing input sound pressure level for a hearing assistance device;
dynamically changing sensitivity of a microphone of the hearing assistance device to change headroom of an input stage of the hearing assistance device based on the sensed input sound pressure level.

2. The method of claim 1, wherein dynamically changing sensitivity of a microphone includes changing a bias voltage of the microphone.

3. The method of claim 1, wherein changing sensitivity includes decreasing sensitivity to increase the headroom.

4. The method of claim 1, wherein changing sensitivity includes increasing sensitivity to decrease the headroom.

5. The method of claim 1, wherein changing sensitivity includes using a predetermined increment level hardcoded in the microphone.

6. The method of claim 1, wherein changing sensitivity includes specifying an increment level.

7. The method of claim 1, wherein changing sensitivity includes switching between a maximum and a minimum sensitivity value.

8. The method of claim 7, wherein switching between a maximum and a minimum sensitivity value includes using a GPIO processor line.

9. The method of claim 1, wherein sensing input sound pressure level includes taking an average over a predetermined time period.

10. A hearing assistance device, including:
an input stage including a microphone configured with variable sensitivity;
hearing assistance electronics connected to the microphone, the hearing assistance electronics configured to process a signal received by the microphone for hearing assistance for a wearer of the hearing assistance device; and
a receiver connected to the hearing assistance electronics and configured to output the processed signal to the user,
wherein the hearing assistance electronics are configured to dynamically change the sensitivity of the microphone to change headroom of the input stage.

11. The device of claim 10, wherein the microphone includes a microelectromechanical system (MEMS) microphone.

12. The device of claim 10, wherein the hearing assistance electronics include a digital signal processor (DSP).

13. The device of claim 10, wherein the hearing assistance device includes a hearing aid.

14. The device of claim 13, wherein the hearing aid includes an in-the-ear (ITE) hearing aid.

15. The device of claim 13, wherein the hearing aid includes a behind-the-ear (BTE) hearing aid.

16. The device of claim 13, wherein the hearing aid includes an in-the-canal (ITC) hearing aid.

17. The device of claim 13, wherein the hearing aid includes a receiver-in-canal (RIC) hearing aid.

18. The device of claim 13, wherein the hearing aid includes a completely-in-the-canal (CIC) hearing aid.

19. The device of claim 13, wherein the hearing aid includes a receiver-in-the-ear (RITE) hearing aid.

20. The device of claim 13, wherein the hearing aid includes an invisible-in-canal (IIC) hearing aid.
